(19) United States
(12) Patent Application Publication
(10) Pub. No.: US 2025/0162182 A1
(43) Pub. Date: May 22, 2025

(54) KNIFE

(71) Applicant: Fiskars Finland Oy Ab, Espoo (FI)

(72) Inventors: Megan DITTRICH, Espoo (FI); Alexander J. HUESMAN, Espoo (FI); Douglas R. NELSON, Espoo (FI)

(21) Appl. No.: 18/957,203

(22) Filed: Nov. 22, 2024

Related U.S. Application Data
(60) Provisional application No. 63/602,280, filed on Nov. 22, 2023.

(51) Int. Cl. B26B 5/00

(52) U.S. Cl. CPC B26B 5/003

(57) ABSTRACT

The present invention relates to a retractable knife (2) comprising a handle (4) and a blade (6) movably mounted to the handle (4). An actuator (14) is movably mounted to the handle (4), and the actuator (14) operatively engages a cam (42) or lever, the cam/lever (42) rotatable into abutment with a linkage (34) operatively with the blade (6), such that movement of the actuator (14) effects movement of the blade (6) between a retracted position where the blade (6) is partially contained within the handle (4), and an extended position where the blade (6) extends from the handle (4).

The present disclosure relates to a knife, into particular but not limited to, a craft knife.

### BACKGROUND OF THE INVENTION

Craft knives may be used to cut paper or card. Typically, a craft knife comprises a handle and a blade. The blade may be replaceable, for example, when the blade becomes dull. Such knives have an exposed blade, which may be dangerous for children and/or may result in dulling of the blade. Safety craft knives may comprise a frangible blade that is slidably received within a housing such the blade can be retracted when not in use.

The inventor has found numerous problems with the prior art devices. Safety blades often have poor ergonomics and may be difficult to handle for children etc. The blades may also be limited in shape in order to provide the frangible form. Replacing blades for the non-retractable craft knives may also be complex and thus difficult for children, for example.

The present disclosure aims to overcome or ameliorate one or more of the above problems.

### STATEMENT OF INVENTION

According to a first aspect, there is provided: a retractable knife comprising: a handle; a blade movably mounted to the handle; an actuator movably mounted to the handle, and where the actuator operatively engages a cam or lever, the cam/lever rotatable into abutment with a linkage operatively engaged with the blade, such that movement of the actuator effects movement of the blade between a retracted position where the blade is partially contained within the handle, and an extended position where the blade extends from the handle.

The linkage comprises a movable shaft or rod. The shaft/rod may extend down the axial length of the handle. The linkage may be received within a core of the handle. The core may comprise a channel or hollow portion to receive the linkage. The channel may be elongate (e.g. extends along the axial length of the handle). The core may form part of the handle (e.g. an external surface thereof). The core may covered by a shroud/housing to form part of the handle. The actuator may move in a linear fashion. The blade may move in a linear fashion (e.g. between extended and retracted position).

The blade may be mounted to blade holder to collectively define a cartridge. The blade/cartridge may be removable/detachable. The cartridge may be mounted to and/or secured within the handle.

The linkage may abut or engage the cartridge (e.g. to drive extension thereof).

The blade may biased toward the retracted position by biasing means (e.g. a spring). The biasing means may be operatively provided between the handle and the cartridge. The spring may engage a head or rim of the cartridge. The biasing means may be operatively provided between the linkage and a core configured to receive the linkage. The linkage may comprise a rim or flange to engage the biasing means.

A portion of the handle may be removable from the knife. The removeable portion may allow removal of the blade/blade cartridge.

The handle may comprise the core to receive the linkage. The removable handle portion may be removably attached to the core. The handle may comprise two housing portions, and one of the housing portions is separable from another housing portion. The housing portion may be connected via a screw thread and/or a bayonet attachment.

The cam may be mounted to the core. The actuator may be mounted to the core. The cam may be snap fit to the core.

The blade may be loosely retained within the knife. The blade may be retained within a channel or hollow in the knife (e.g. in the handle). The blade may be loosely engaged with the linkage (i.e. not rigidly fixed thereto). The blade may be rotatable about an axis defined by the axial length of the handle (i.e. the position of the blade or blade cartridge is axial fixed, but rotation thereof is permitted).

The blade may be attached/connected to the linkage. The blade may be removably attached to the linkage. The blade or blade cartridge may comprise a snap fit with the linkage. One of the linkage and the blade may comprise a head portion and a neck portion. The other of the linkage and the blade may comprise a recess and constriction configured to provide a snap-fit with the neck portion.

The blade cartridge may comprise a first portion to retain the blade. The blade cartridge may comprise a second portion to define said neck portion. The first and second portions may be connected via snap fit.

The actuator may comprise a cap. The cap may be located at an opposing end of the handle to blade. The cap may be bulbous and/or may protrude outwardly from the transverse width of the handle. The cam and/or lever may be fully contained within the cap/actuator.

The cam may comprise a lever. A portion of the lever is received within a recess on the actuator. The lever may comprise a head portion. The head portion may be rotatably received with the recess. The cam may comprise an eccentric surface configured to engage the linkage.

A bearing may be interposed the blade or blade cartridge and handle to aid with movement therebetween. The bearing may comprise a sleeve. A biasing means may be interposed the bearing and the handle.

The actuator may move in a first direction and the blade moves in a second, opposing direction. During actuation, the actuator may move a first distance and the blade may move a second, shorter distance. The cam/lever may provide a non-unity gear ratio. The first distance may be between 1.5 and 2.5 times larger than the first distance.

The blade may comprise a ceramic material. The knife may comprise a craft knife.

A portion of the handle may comprise a high friction surface. The high friction surface may comprise a rubber coating. The high friction surface may be provided on a removable portion of the handle (e.g. a handle shroud).

According to a further aspect, there is provided: a retractable knife comprising: a handle; a blade movably mounted to the handle; an actuator movably mounted to the handle configured to move the blade between a retracted position where the blade is partially contained within the handle, and an extended position where the blade extends from the handle; and where the blade is mounted to a blade holder to define a cartridge, and where the cartridge is removably mounted to the handle.

A retractable knife comprising: a handle; a blade movably mounted to the handle; an actuator movably mounted to the handle configured to move the blade between a retracted position where the blade is partially contained within the handle, and an extended position where the blade extends from the handle; and where the blade is mounted to a blade holder to define a cartridge, and where the cartridge is rotatably mounted to the handle, such that the cartridge may rotate about an axis defined by the axial length of the handle.

Any aspect of the invention may be combined with any other aspect of the invention where practicable.

### DESCRIPTION

Embodiments of the present invention are described below, by way of example only, with reference to the accompanying drawings:

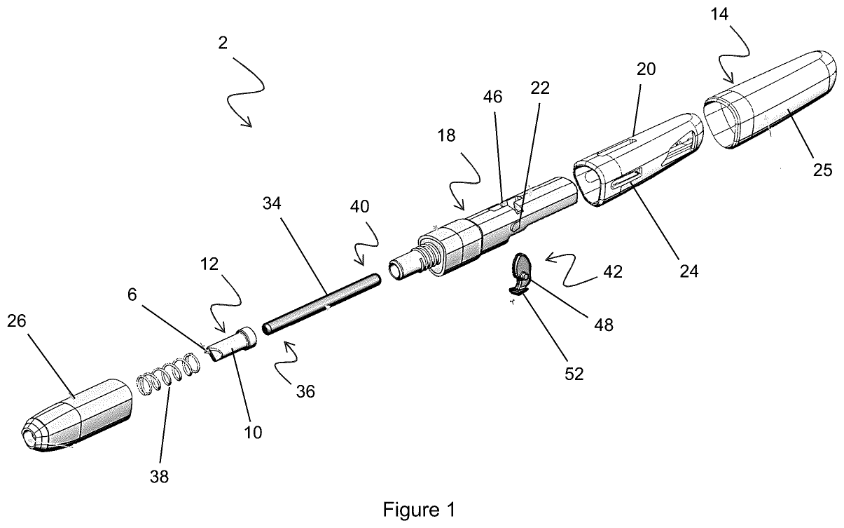

FIG. 1 shows an exploded view of a first embodiment of a craft knife;

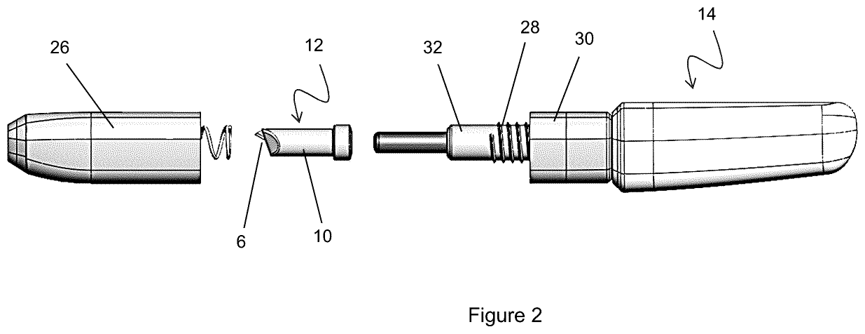

FIG. 2 shows a side view of the first embodiment of the craft knife;

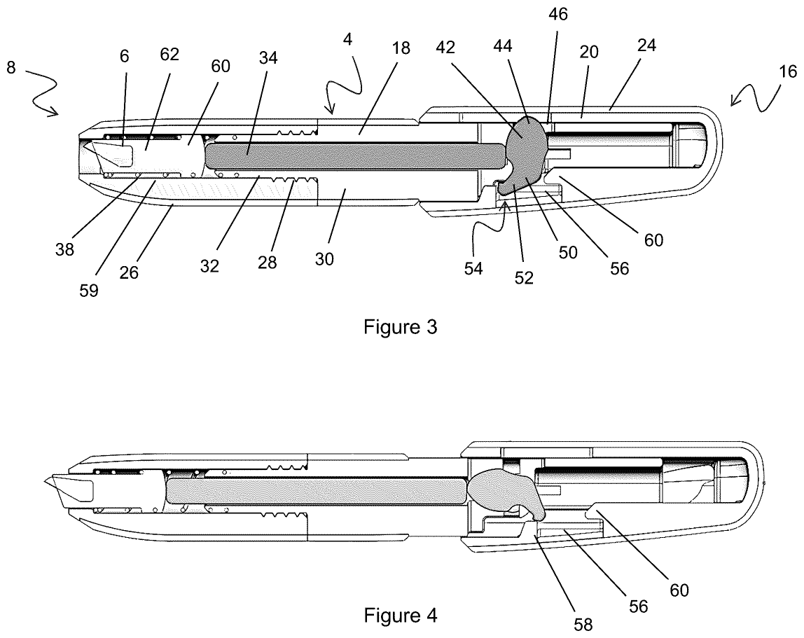

FIG. 3 shows a sectional side view of the first embodiment of the craft knife in a retracted state;

FIG. 4 shows a sectional side view of the first embodiment of the craft knife in an extended state;

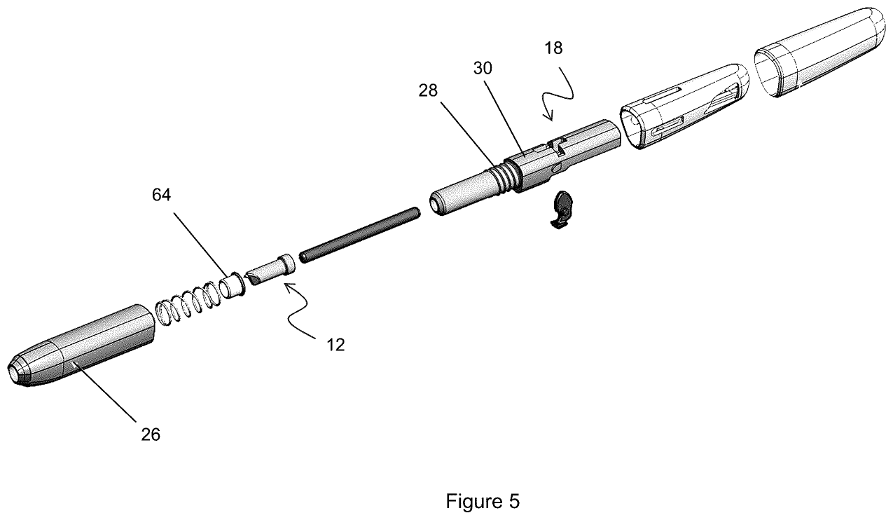

FIG. 5 shows an exploded view of a second embodiment of a craft knife;

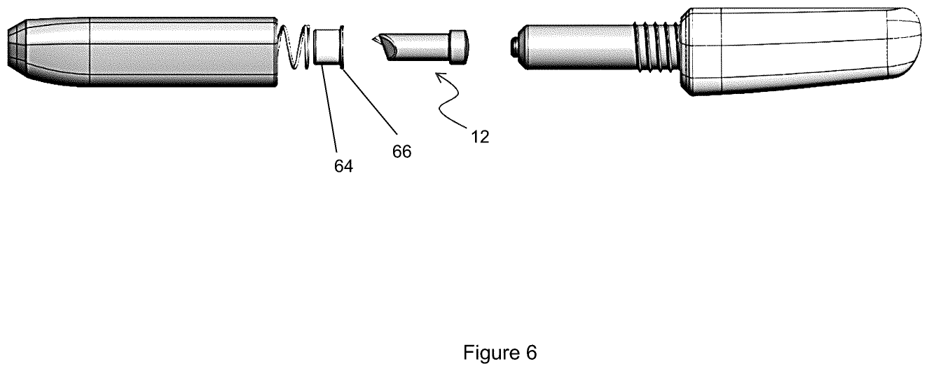

FIG. 6 shows a side view of the second embodiment of the craft knife;

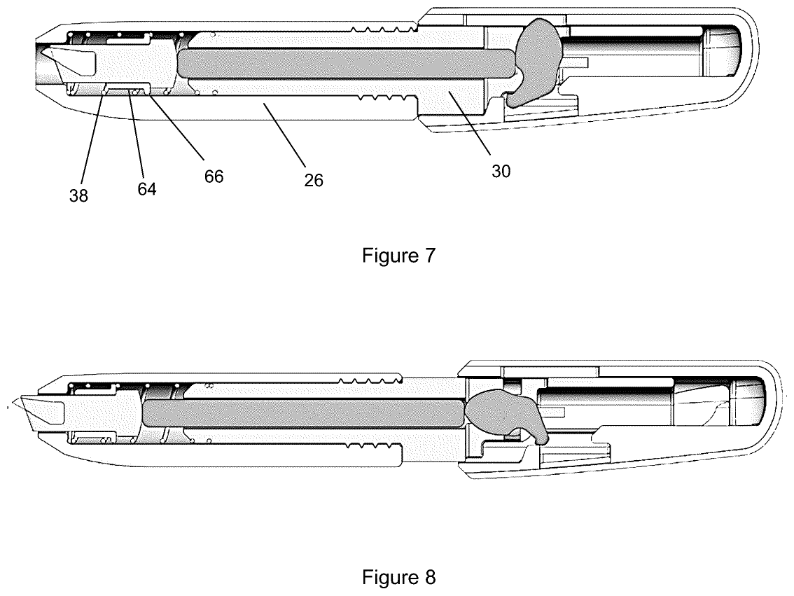

FIG. 7 shows a sectional side view of the second embodiment of the craft knife in a retracted state;

FIG. 8 shows a sectional side view of the second embodiment of the craft knife in an extended state;

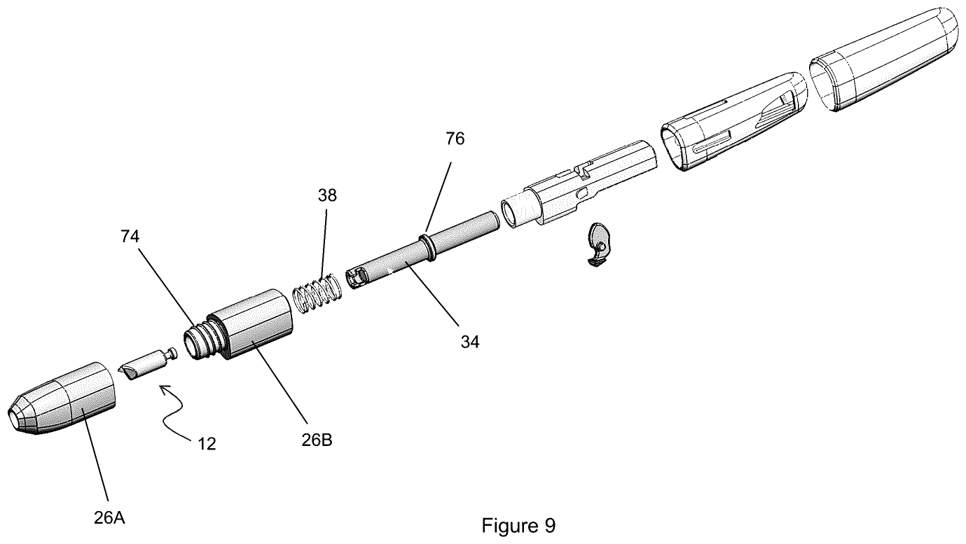

FIG. 9 shows an exploded view of a third embodiment of a craft knife;

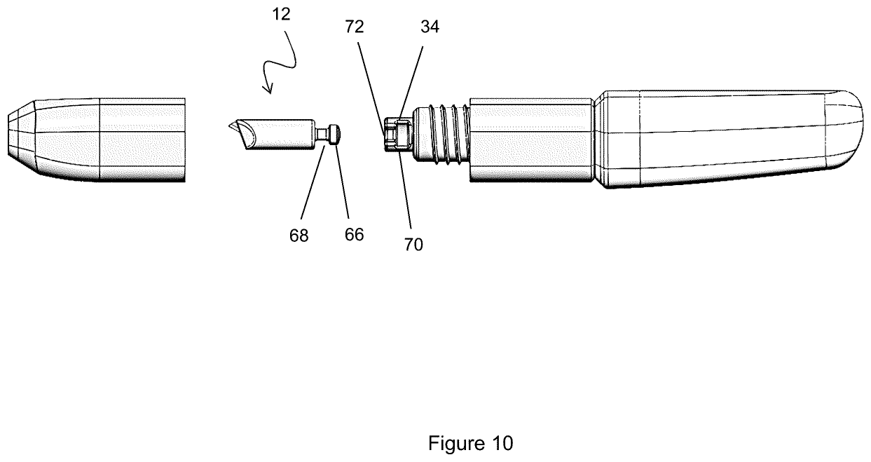

FIG. 10 shows a side view of the third embodiment of the craft knife;

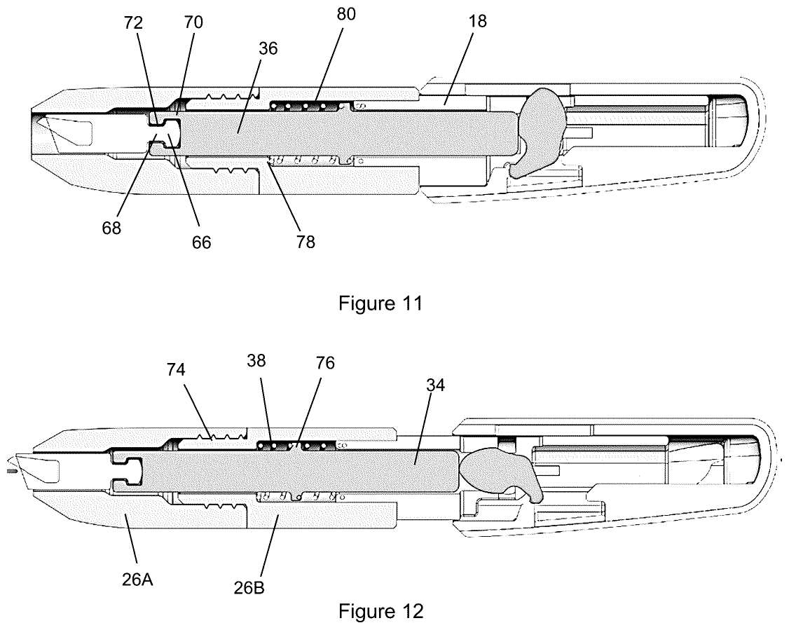

FIG. 11 shows a sectional side view of the third embodiment of the craft knife in a retracted state;

FIG. 12 shows a sectional side view of the third embodiment of the craft knife in an extended state;

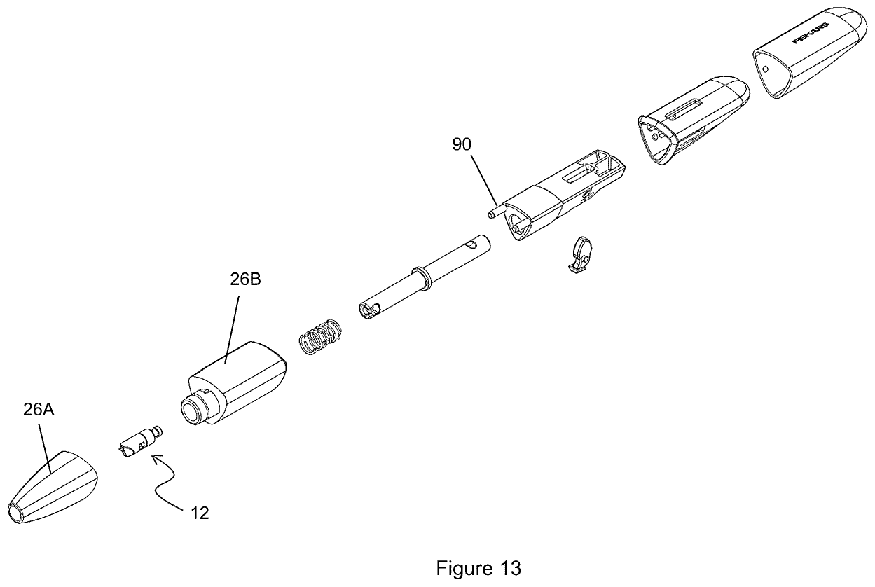

FIG. 13 shows an exploded view of a fourth embodiment of a craft knife;

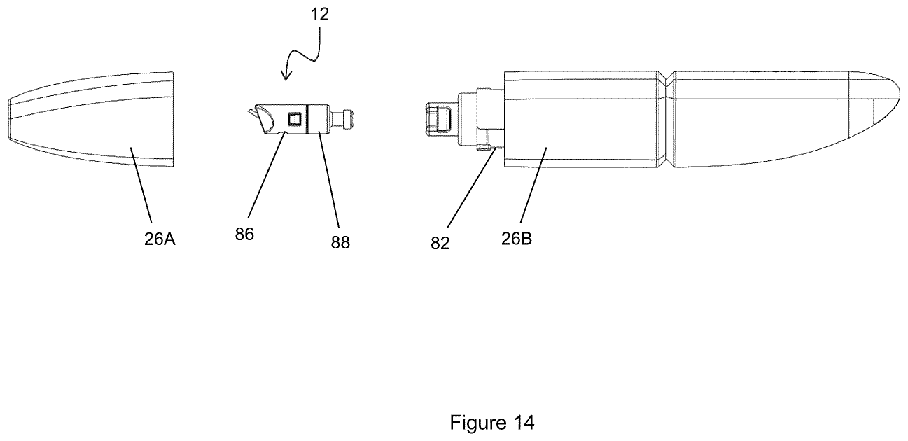

FIG. 14 shows a side view of the fourth embodiment of the craft knife;

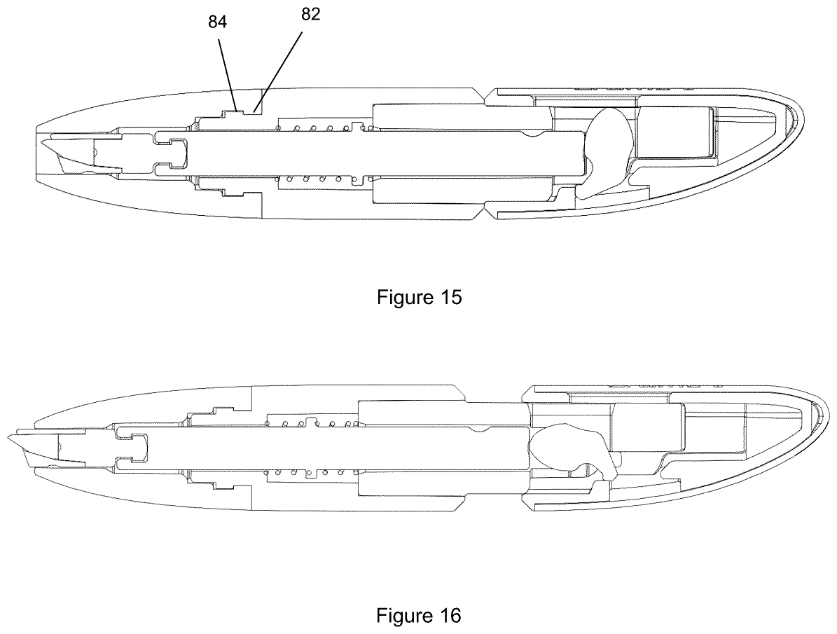

FIG. 15 shows a sectional side view of the fourth embodiment of the craft knife in a retracted state;

FIG. 16 shows a sectional side view of the fourth embodiment of the craft knife in an extended state.

A knife or cutter 2 is shown in FIGS. 1-4. The knife 2 comprises a craft knife for cutting, inter alia, paper, card, cardboard, felt, plastic etc. It can be understood that the exact use of the knife is not pertinent to the invention at hand. The knife 2 comprises a handle portion 4. The handle 4 allows the user to grip the knife 2 in use. The handle 4 may be ergonomically shaped. The handle 2 comprises a polymeric material, for example, acrylonitrile butadiene styrene (ABS). The handle 4 comprises a generally elongate/tubular form.

A blade 6 is provided at a first end 8 of the handle 4. The blade 6 may comprise a scalpel type blade (i.e. the apex/tip thereof comprise an acute angle). The blade 6 is held/fixed to a blade holder 10. The blade 6 and blade holder 10 may collectively define a cartridge 12. The cartridge may be replaceable to allow replacement of blade 6. The cartridge 12 provides a simple means to replace the blade 6, without needing to directly handle the blade 6. The blade 6 may comprise a thickness between 0.4 mm and 0.8 mm. The blade 6 may comprise a ceramic material. The blade may comprise zirconium oxide. The blade 6 may comprise hardened steel.

An actuator 14 is provided at a second end 16 of the handle 4 (i.e. at an opposite end of the handle 2 to the blade 6). The actuator 14 is movably mounted to the handle 4. The actuator 14 is movable along the axial length of the handle 4 (i.e. toward/away from the blade 6). The actuator 14 is mounted to a core 18. The actuator 14 comprises an internal portion 20 configured to be movably mounted to the core 18 in use. The internal portion 20 is generally elongate. The internal portion 20 is hollow to receive the core 18. An inner surface of the internal portion 20 comprises a similar shape to the outer surface of the core 18 to provide a close fit therewith. The core 18 comprises a retaining protrusion 22 configured to be received by a corresponding slot 24 in the internal portion 20 (best seen in FIG. 1). This protrusion 22 can slide along the slot 24 in use to allow movement of the actuator 14, whist retaining the actuator 14 on the handle 4. Although only a single protrusion 22 is shown in FIG. 1, a further protrusion 22 is provided on an opposing side of the core 18. Additionally or alternatively, a protrusion is provided on the internal portion 20 and received in a slot on the core 18. The internal portion 20 may be snap-fit onto the core 18.

A shroud 25 is mounted to the internal portion 20. The shroud 25 covers the internal portion 20. The shroud 25 covers the slot 24, for example, to prevent interference therewith. The shroud 25 may be snap-fit and/or adhered to the internal portion 20. The actuator 14 projects outwardly from the side of the handle 4 (i.e. comprises a greater with the handle 4). This allows the user to more easily grasp the actuator 14. The actuator 14 may comprise a rounded or bulbous shape.

The core extends 18 along the inside of the handle 4. A handle shroud 26 is configured to at least partially cover/enclose the core 18. The handle shroud 26 comprises a close fit with the core 18. The handle shroud 26 is detachable from the core 18. This allows access to the cartridge 12 to allow replacement thereof. For example, the handle shroud 26 and core 18 comprises a screw thread 28 to allow attachment/separation thereof. It can be appreciated that any suitable attachment mechanism may be provided, for example, interference fit, snap fit (e.g. one of the handle shroud 26 and core 18 comprises a protrusion configured to snap into a recess on the other of the handle shroud 26 and core 18), indent and resilient detent arrangement, latch etc.

The core 18 comprises a wide portion 30. The wide portion 30 is provided adjacent the actuator 14. The wide portion is a similar width as the handle 6 (e.g. greater than 80% the width thereof). The core 18 comprises a narrow portion 32. The narrow portion 32 is provided toward the blade 6. The narrow portion is less than 60% of the width of the handle 6. The narrow portion 32 allows provision of the screw thread 28. The handle shroud 26 comprises a greater wall thickness in the portion overlying the narrow portion 32 to ensure the handle 6 has sufficient rigidity. The screw thread 28 is provided on the narrow portion 32 to allow accommodation thereof within the shroud 26.

A rod or shaft 34 is provided within the core 18. The shaft 34 is movable (i.e. slidable) within the core 18. The shaft 34 may comprise a plastic material and/or aluminium. A first end 36 of the shaft 34 is configured to abut/engage the blade cartridge 12. The shaft 34 thus provides a linkage. The knife 2 comprises a spring 38 configured to bias the cartridge 12 into a position where the blade 6 is contained within the handle 4 (see FIG. 3). A second end 40 of the shaft 34 is configured to engage a cam 42. The cam comprises an eccentric surface 44. There, upon rotation of the cam 42, the eccentric surface 44 drives the shaft 34 along the core 18 (see FIGS. 3 and 4). As the shaft 34 is moved toward the cartridge 12, the cartridge is pushed out from the handle 4 to expose the blade 6. If the cam 42 is rotated back to the original position, the shaft 34 is free to retract under action of the spring 38.

The cam 42 is mounted to the core 18. The core 18 comprises a slot 46 to receive the cam 42. The cam 42 comprises protrusions 48 either side thereof configured to snap fit into the core 18 to provide a rotatable pivot point. The cam 42 comprises a lever 50. The lever 50 protrudes outwardly from the cam 42 to effect rotation thereof. The lever 50 is angled with respect to a radial direction of the cam 42 (i.e. extends in a radial and tangential direction). A head portion or protrusion 52 is provided at end 54 of the lever 50. The head portion 52 extends outwardly from the plane of the cam 42 (best seen in FIG. 1). The head portion 52 extends outwardly from the lever 50 in the plane of the cam 42.

The lever 50 therefore comprises a hook shape. The end 54 of the lever 50 (e.g. the head portion 52) is configured to engage the actuator 14. The actuator 14 comprises a recess 56 to accommodate the head portion 52. When the actuator 14 is moved away from the blade 6, the lever 50 is rotated away from the blade 6 accordingly. This rotates that cam 42 such that the eccentric surface 44 into engagement with the shaft 34, thereby extending the blade cartridge 12. As the actuator 14 is moved away from the blade 6, the head portion 52 abuts a first side or rim 58 of the recess 56. As the actuator 14 is moved back toward the blade 6, the head portion 52 a second side or rim 60 of the recess 56 abuts the head portion 52 to rotate the cam 42 back into the configuration in FIG. 3.

The cam 42 and lever 50 are fully contained within knife 2. In particular, no part thereof extends out from the actuator/cap 14. This helps to prevent interference with the operation of the actuation mechanism during use.

The actuator 14 is therefore movable to effect movement of the blade 6/blade cartridge. The actuator 14 is configured to be pulled to extend to the blade 6. This provides a safer configuration, as it is generally more difficult to inadvertently pull the actuator 14, rather than push the actuator 14. The actuator 14 is therefore moved in a first direction to extend the blade 6 in an opposing second direction. In alternative embodiments, the actuator 14 may be pushed toward the blade 6 to extend the blade 6. For example, the cam surface 44 engages when shaft 34 when the actuator 14 is provided in a position toward the blade 6, and the cam surface 44 disengages the shaft 34 when the actuator 14 is displace away from the blade (e.g. the cam surface 44 is provided in position 90 degrees anticlockwise than that shown in present embodiment). The actuator 14 and blade 6 move in a linear fashion.

The actuator 14 is configured to be pulled by a first distance to extend the blade cartridge 12 by a second, smaller distance. The actuator 14 and the cartridge are therefore connected via a gear mechanism. The gear mechanism is effectively provided by the lever 50 and the cam surface 44. The effective distance of the lever 50 and cam surface 44 from the pivot point define the effective gearing ratio (e.g. the longer the lever 50, the more the actuator 14 must be moved to move the cartridge 12 a certain distance). In the present embodiment, the actuator 14 is configured to move by 6-10 mm. The blade cartridge 12 is configured to move by 1-4 mm. In a specific embodiment, the actuator 14 moves 8 mm and the blade cartridge 4 mm. The actuator 14 moves a distance 1.5-2.5 times further than the blade cartridge moves.

The blade cartridge 12 is loosely held within a channel 59 within the handle shroud 26. This allows the cartridge 12 to freely extend/retract. Furthermore, the cartridge 12 may be free to rotate about the axial length thereof. The cartridge comprises a head portion 60. The head portion 60 is sized to provide a close fit with the shroud 26 without providing excessive friction. The blade holder 10 comprises a shaft portion 62 of reduced width. The shaft portion 62 secures the blade 6 to the cartridge 12. The reduced width further allows space for the spring 38. The head portion 60 ensures the cartridge 12 remains captive within the handle.

In order to use the knife 2, the user may first insert (or replace) the blade cartridge. The handle shroud 26 is unscrewed from the core 18 and the cartridge 12 placed therein. The handle shroud 26 is screwed back onto the core 18. The user then pulls the actuator 14 to extend the blade 6, and then pushes the actuator 14 back to retract the blade 6. The removable shroud 26 allows easy replacement of the blade cartridge 12 without the use of tools etc.

A second embodiment of the knife 2 is shown in FIGS. 5-8. The knife 2 and the operation thereof is substantially the same as the first embodiment of the knife 2, and like features will not be repeated for the sake of brevity.

The wide portion 30 of core 18 is axially shorter than the first embodiment. The screw threads 28 are thus provided closer to the actuator 14 accordingly. A relatively large portion of the handle shroud 26 is therefore removed in use. The shroud 26 may comprise a rubberised coating. For example, the shroud 26 may comprise a plastic base (e.g. ABS) with a rubber paint coating.

A bearing 64 is provided between the cartridge 12 and the handle shroud 26. The bearing 64 comprises a sleeve configured to receive the blade holder 10. The bearing 64 comprises an outstanding rim 66 configured to engage the shroud 26. The rim 66 is configured to abut against the head portion 60 of the cartridge 12 and the spring 38 (i.e. interposed therebetween). The bearing 64 may comprise a low friction material. The bearing 64 may comprise stainless steel. The bearing 64 may comprise a polished surface.

A third embodiment of the knife 2 is shown in FIGS. 9-12. Again, like features will not be described in detail. The blade cartridge 12 is removably attached to the shaft 34. The cartridge 12 comprises a head portion 66 and a neck portion 68 between the head portion 66 and cartridge 12. The first end 36 of the shaft 34 comprises a recess 70 configured to receive the head portion 66. The recess 70 is shaped to provide a close fit with the head portion 66. The recess 70 comprises a constriction 72 configured to provide a snap-fit connection with the neck (see FIG. 10). The constriction 72 comprises a spacing/gap marginally smaller than the width of the neck 68 to provide said snap fit. The head 66 and neck 68 are rotationally symmetrical to allow rotation thereof.

The handle shroud 26 comprises two separable pieces 26A and 26B. A screw thread 74 is provided to facilitate connection therebetween. It can be appreciated that any suitable attachment mechanism may be provided. A first piece 26A is configured to cover the cartridge 12 and/or allow access thereto. The screw threads 74 are proximal the end 36 of the shaft 34. The second portion 26B forms the remainder of the handle 4.

The spring 28 is operatively provided between the shaft 34 and the core 18. The spring 28 is therefore displaced from cartridge 12. The shaft 34 comprises a flange/rim 76 to retain the spring 28. The spring 28 is provided between the flange 76 and an end face 78 of a recess 80 within the second shroud portion 26B. The recess 80 is wider than the width of the shaft 34 to accommodate the spring 28.

A fourth embodiment of the knife 2 is shown in FIGS. 13-15. Again, like features will not be repeated for the sake of brevity. The two housing pieces 26A and 26B are connected via a bayonet connection. The second housing piece 26B comprise a L-shaped groove 82 to receive a corresponding protrusion 84 on the first piece 26A (see FIGS. 15 and 16). The protrusion 84 is inserted axially into the groove 82, and the first piece 26A is rotated such that the protrusion 84 is retained within the groove 82. This provides a quicker and easier way to remove the first piece 26A than the aforementioned screw threads.

The blade cartridge 12 comprises a two-piece construction. A first piece 86 comprises a housing to receive the blade 6. A second piece 88 comprises a handle portion to connect to the shaft 34 in use, as previously described. The second piece 88 is configured to snap-fit into the first piece 86. The first piece 86 and/or second piece 88 may comprise polyoxymethylene (POM).

The core 18 comprises a dowl 90 configured to be received with the housing 26. Adhesive or the like may be provided on the dowl to form a secure connection between the core 18 and the housing 26. In other embodiments, a dowl is provided housing 26, or both the housing 26 and the core 18

The present disclosure provides a simple and effective means to extend or retract the blade. This may find particular benefit for children or less-abled people. The blade is attached in a removable fashion that also allows rotation thereof. The blade cartridge allows easy and safe handling of the blade (e.g. for replacement thereof).

1. A retractable knife comprising:
a handle;
a blade movably mounted to the handle;
an actuator movably mounted to the handle, and where the actuator operatively engages a cam or lever, the cam/lever rotatable into abutment with a linkage operatively engaged with the blade, such that movement of the actuator effects movement of the blade between a retracted position where the blade is partially contained within the handle, and an extended position where the blade extends from the handle.

2. A retractable knife according to claim 1, where the linkage comprises a movable shaft extending down the axial length of the handle.

3. A retractable knife according to claim 1, where the blade is mounted to blade holder to collectively define a cartridge

4. A retractable knife according to claim 2, where the linkage abuts the cartridge.

5. A retractable knife according to claim 1, where the blade is biased toward the retracted position by biasing means.

6. A retractable knife according to claim 5, where the biasing means is operatively provided between the handle and the cartridge.

7. A retractable knife according to claim 5, where the biasing means is operatively provided between the linkage a core configured to receive the linkage.

8. A retractable knife according to claim 1, where a portion of the handle is removable from the knife to allow removal of the blade.

9. A retractable knife according to claim 8, where the handle comprises the core to receive the linkage, and the removable handle portion is removably attached to the core.

10. A retractable knife according to claim 1, where the handle comprises two housing portions, and one of the housing portions is separable from another housing portion.

11. A retractable knife according to claim 1, where the blade is rotatable about an axis defined by the axial length of the handle.

12. A retractable knife according to claim 1, where the blade is removably attached to the linkage.

13. A retractable knife according to claim 1, where the actuator comprises a cap located at an opposing end of the handle to blade.

14. A retractable knife according to claim 13, where the cap is bulbous and/or protrudes outwardly from the transverse width of the handle.

15. A retractable knife according to claim 13, where the cam and/or lever are fully contained within the cap.

16. A retractable knife according to claim 1, where a bearing is interposed the blade and handle to aid with movement therebetween.

17. A retractable knife according to claim 1, where the actuator is moved in a first direction and the blade moves in a second, opposing direction.

18. A retractable knife according to claim 1, where during actuation, the actuator moves a first distance and the blade moves a second, shorter distance.

19. A retractable knife comprising:
a handle;
a blade movably mounted to the handle;
an actuator movably mounted to the handle configured to move the blade between a retracted position where the blade is partially contained within the handle, and an extended position where the blade extends from the handle;
and where the blade is mounted to a blade holder to define a cartridge, and where the cartridge is removably mounted to the handle.

20. A retractable knife comprising:
a handle;
a blade movably mounted to the handle;
an actuator movably mounted to the handle configured to move the blade between a retracted position where the blade is partially contained within the handle, and an extended position where the blade extends from the handle;
and where the blade is mounted to a blade holder to define a cartridge, and where the cartridge rotatably mounted to the handle, such that the cartridge may rotate about an axis defined by the axial length of the handle.
